(19) United States
(12) Patent Application Publication
(10) Pub. No.: US 2018/0157763 A1
(43) Pub. Date: Jun. 7, 2018

(54) SYSTEM AND METHOD FOR GENERATING AN ELECTRONIC PAGE

(71) Applicant: TYLIO INC., Saint-Lambert (CA)

(72) Inventor: Tanguy LAYS, Saint-Lambert (CA)

(21) Appl. No.: 15/736,458

(22) PCT Filed: Jun. 16, 2016
(86) PCT No.: PCT/CA2016/050698

§ 371 Date: Dec. 14, 2017

Related U.S. Application Data
(60) Provisional application No. 62/181,601, filed on Jun. 18, 2015.

(51) Int. Cl. G06F 17/30

(52) U.S. Cl. CPC G06F 17/30893; G06F 17/227; G06F 17/30896

(57) ABSTRACT

A system and method for generating an electronic page includes receiving a set of electronic content items for inclusion in the electronic page to be generated. One or more match codes are determined for the set of electronic content items. Electronic page parts that are relevant to the set of electronic content items is further determined. An electronic page is generated from the set of electronic content items and the one or more relevant electronic page parts.

### CROSS-REFERENCE TO RELATED APPLICATIONS

The present application claims priority on U.S. 62/181,601 filed on Jun. 18, 2015, which is hereby incorporated by reference in its entirety.

### FIELD OF THE DISCLOSURE

The present disclosure relates to systems, methods and tangible computer readable medium for generating electronic pages, more particularly, using relevant electronic page parts.

### BACKGROUND OF THE DISCLOSURE

In many situations, there is a desire to create a visually pleasing electronic page that can be viewed on an electronic display, such as the display of a desktop computer, laptop, tablet, smartphone or television. For example, such an electronic page may be a webpage. Such electronic page may be useful both in a commercial context (ex: company webpage) or non-commercial context (ex: a personal webpage).

However, the process for creating an electronic page can often be lengthy and not user-friendly. Often, the creation of a page may require extensive training and experience and knowledge of programming/markup languages and principles.

The use of templates can simplify the creation process. However, this use can result in many pages having the same look and feel as other pages. Changing, customizing or adapting from the template can again be lengthy, not user-friendly, and require knowledge and experience with programming/markup languages and principles.

Electronic pages, especially website, that are created are often static, in that the same look of the page is to be displayed on a variety devices and in a variety of viewing situations. This may result the page to be difficult to view or viewed sub-optimally.

### SUMMARY

It would thus be highly desirable to be provided with an apparatus, system or method that would at least partially address the disadvantages of the existing technologies.

The embodiments described herein provide in one aspect a method for generating an electronic page, the method comprising receiving a set of electronic content items for inclusion into the electronic page, determining one or more content match codes for the set of electronic content items, determining from a database of stored electronic page parts one or more relevant electronic page parts, each stored electronic page part being associated with one or more part match codes, a given stored electronic page part being identified as one of the relevant electronic parts based on a correspondence between its one or more part match codes and the one or more content match codes determined for the set of electronic content items, and generating an electronic page from the set of electronic content items and the one or more relevant electronic page parts.

The embodiments described herein provide in another aspect a system for generating an electronic page, the system comprising a memory for storing a plurality of instructions a processor coupled to the memory. The processor is configured for receiving a set of electronic content items for inclusion into the electronic page, determining one or more content match codes for the set of electronic content items, determining from a database of stored electronic page parts one or more relevant electronic page parts, each stored electronic page part being associated with one or more part match codes, a given stored electronic page part being identified as one of the relevant electronic parts based on a correspondence between its one or more part match codes and the one or more content match codes determined for the set of electronic content items, and generating an electronic page from the set of electronic content items and the one or more relevant electronic page parts.

The embodiments described herein provide in yet another aspect a tangible computer readable medium including computer executable instructions which, when executed on a computing device, cause the computing device to carry out the method.

### DRAWINGS

The following drawings represent non-limitative examples in which:

FIG. 1 is a block diagram illustrating an example embodiment of a network that includes a system for generating an electronic page;

FIG. 2 is a block diagram illustrating the modules of the example embodiment of the system for generating an electronic page;

FIGS. 3A to 3D illustrate example layouts of placeholders;

FIG. 4 is a block diagram illustrating an example embodiment of a data structure of stored electronic page parts;

FIG. 5A illustrates an exemplary hierarchical organization of style identifiers for public use;

FIG. 5B illustrates an exemplary hierarchical organization of style identifiers for private use;

FIG. 6 is a flow chart diagram illustrating an example embodiment of a method for the generation of an electronic page;

FIG. 7 is a flow chart diagram illustrating an example embodiment of a detailed method for the generation of an electronic page;

FIG. 8 is a block diagram illustrating an example embodiment of detailed data modules of the example embodiment of the system for generating an electronic page;

FIG. 9 is a block diagram illustrating an example embodiment of data flow within the system for generating an electronic page;

FIG. 10 illustrates an example environment for initiating electronic page generation;

FIG. 11 illustrates an example environment for selecting electronic content items for the generation of an electronic page;

FIG. 12 illustrates the example environment for selecting electronic content items for the generation of an electronic page having some selected electronic content items;

FIG. 13 illustrates an example environment for the addition of a textual content item for the generation of an electronic page;

FIG. 14 illustrates an example environment for the addition of multimedia content items for the generation of an electronic page;

FIG. 15 illustrates an example environment for the addition of a link content item for the generation of an electronic page;

FIG. 16 illustrates an example environment for the addition of a map content item for the generation of an electronic page;

FIG. 17 illustrates an example environment for the addition of social networking content item for the generation of an electronic page;

FIG. 18 illustrates an example generated electronic page that is a webpage;

FIG. 19 illustrates an example generated electronic page that is a webpage; and

FIG. 20 illustrates an example environment for publishing and sharing the generated electronic page;

### DESCRIPTION OF VARIOUS EMBODIMENTS

The following examples are presented in a non-limiting manner.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The terms “coupled” or “coupling” as used herein can have several different meanings depending on the context in which these terms are used. For example, as used herein, the terms coupled or coupling can indicate that two elements or devices are directly connected to one another or connected to one another through one or more intermediate elements or devices via an electrical element, electrical signal or a mechanical element depending on the particular context.

The term “electronic page” as used herein refers to an electronic file or group of electronic files that may be displayed as one or more pages on an electronic display, such as the display of a desktop computer, laptop, tablet, smartphone, television or other suitable display. The electronic page may be a web page, a formatted electronic document, presentation, poster, online course, tutorial or other suitable electronic document.

The various embodiments of the systems and methods described herein may be implemented in hardware or software, or a combination of both. For example, some embodiments may be implemented in computer systems and computer programs, which may be stored on a physical computer readable medium, executable on programmable computers (e.g. computing devices and/or processing devices) each comprising at least one processor, a data storage system (including volatile and non-volatile memory and/or storage elements), at least one input device (e.g. a keyboard, mouse or touchscreen), and at least one output device (e.g. a display screen, a network, or a remote server). For example, and without limitation, the programmable computers may include servers, personal computers, laptops, tablets, personal data assistants (PDA), cell phones, smart phones, gaming devices, and other mobile devices. Program code can be applied to input data to perform the functions described herein and to generate output information. The output information can then be supplied to one or more output devices for outputting to one or more users.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloadings, magnetic and electronic storage media, digital and analog signals, and the like. The computer-usable instructions may also be in various forms including compiled and non-compiled code.

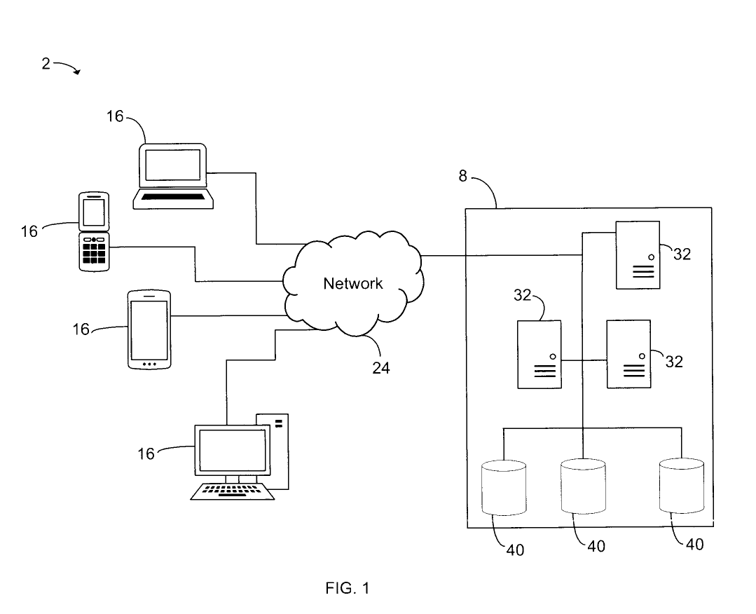

Referring now to FIG. 1, shown therein is an example embodiment of a network 2 that includes a system 8 for generating an electronic page. One or more user devices 16 can communicate with the page-generating system 8 via a network 24.

The user devices 16 can be any computing devices generally suitable for facilitating communication with the page-generating system 8 over the network 24. For example, the user device 16 could be a laptop, personal data assistant, smart phone, desktop computer, tablet, set-top box, or video game console. For example, the user device 16 can run one or more of a variety of operating systems or platforms, such as Windows, Mac OS, OS X, iOS or Android.

The user devices 16 may be connected to the page-generating system 8 via any suitable communications channel. For example, the computing may communicate over the network 24 that is a local area network (LAN) or Intranet) or using an external network, such as, by the Internet. Communication may be carried out using a standalone app or a browser operating on the user device. It will be appreciated that communication between the user devices 16 and the page-generating system 8 may be carried out over a wired network, wireless network, or a combination thereof.

In some cases, one or more human users interacting with the user devices 16 may be required to authenticate their identities in order to communicate with the page-generating system 8. For example, the user devices 16 may be required to input a login name and/or a password or otherwise identify themselves to gain access to the page-generating system 8.

In other cases, one or more users (e.g. “guest” users) may be able to access the page-generating system 8 without authentication. Such guest users may be provided with limited access, such as access to a limited set of features of the page-generation environment, for example, to decide whether they would like to make use of the page-generation environment.

The page-generation system generally includes a number of functional components for providing the service of generating an electronic page. For example, the page-generating system 8 generally includes one or more processing devices 32 (ex: servers, workstations), each having one or more processors. The processing devices 32 are configured to carry out various computing steps for generating an electronic page, as described elsewhere herein. The processing devices 32 are also configured to send information (ex: HTML or other data) to be displayed on the one or more user devices 16. In some cases, the processing device 32 may be of a similar type as one of the user devices 16 (ex: laptop or desktop computer). Steps of generating the electronic page may be shared between the processing devices 32 and processing devices of the user devices 16.

The page-generating system 8 also generally includes one or more data storage devices 40 (ex: memory, etc.) that are in communication with the processing devices 32, and could include a relational database (such as a SQL database), or other suitable data storage devices. The data storage devices 40 are configured to host data related to the generation of electronic pages, as described elsewhere herein.

The data storage devices 40 are configured to also store user-related information, such as user-defined preferences, user-related information collected from external systems (ex: social-network activities), user profiles, user permissions, and data related to electronic page generating activities carried out by a user, such as generated pages.

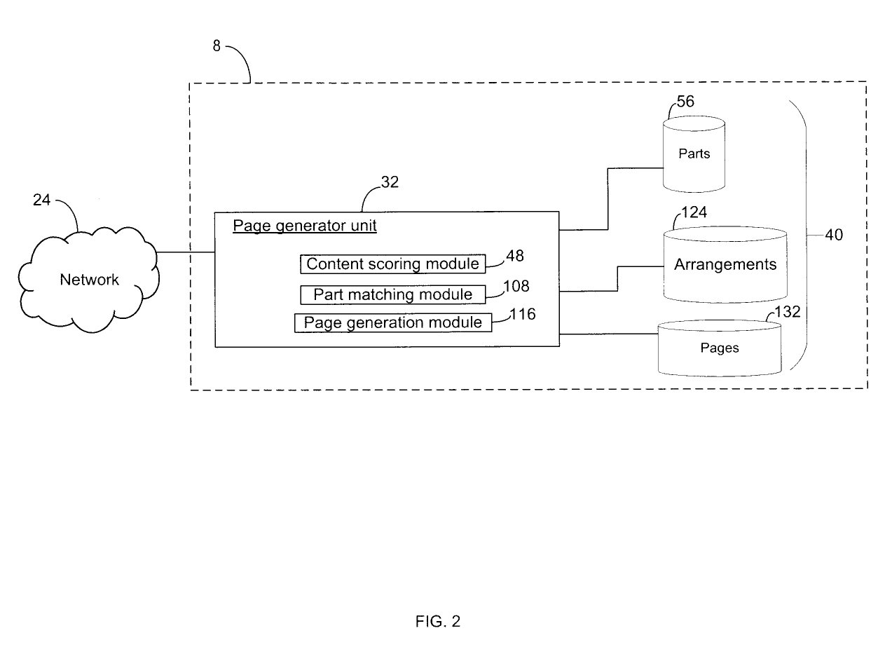

Referring now to FIG. 2, therein illustrated is a block diagram of an example embodiment of a system 8 for generating electronic pages. The system 8 includes the one or more processing devices upon which are implemented a plurality of modules. The modules may be implemented in hardware or software or a combination of both on the one or more processing devices 32. For example, functionalities of the modules are carried out by the one or more processors of the one or more processing devices 32. The page-generation system 8 further includes the data storage 40 upon which are implemented a plurality of data storages. Some parts of the modules may be implemented on a processing device of one or more user devices 32.

The page generation system 8 includes a content scoring module 48. The scoring module 48 receives electronic content items that have been selected for inclusion into the electronic page that is to be generated.

The electronic content items may be any form of electronic content that can be displayed, executed or played back within an electronic page. For example, the electronic content items may be any one or more of multimedia content, images, graphics, text, comments, links, audio, video, maps, social media feed, and interactive web content.

Some or all of the electronic content items may be selected by a user interacting with one or more of the user devices 16. For example, via a content-selection environment displayed on the one or more user devices 16, a user may select content items stored locally at device 16 and upload them to the page-generation system 8 via the network 24.

Some or all of the electronic content items may be stored externally of the page-generation system 8 and the user devices 16. For example, the electronic content items may be stored on a cloud-based file storage system, such as Box™, DropBox™ Windows Live™, Google Drive™, Tumblr™, Flickr™ or similar systems. The user may interact with one or more of the user devices 16 to provide links to the externally stored electronic content items.

Some or all of the electronic content items may be already stored within the page-generation system 8. For example, electronic content items may have been previously uploaded by the same user. Electronic content items may be provided by the page-generation system 8 for use by users. Electronic content items may also have been uploaded by another user and shared for use with specific users, within a defined user group or for public use at large.

According to various exemplary embodiments, the page-generation system 8 may be further configured to automatically select some electronic content items to be included within the set of electronic content items for generating the electronic page. The automatic selection may be carried out based on deep learning algorithms applied at various steps of the process for generating the electronic page, such as during user interactions during the generation, user properties, contextual properties, metrics related to already generated pages (ex: views, likes, comments, shares and more). The automatic selection may also be based on automatically determined purpose of the page to be created.

Received electronic content items are bundled within a set. A set of electronic content items represents a grouping of related content items and are intended to be included together within a single electronic page or a set of related electronic pages.

The content scoring module 48 is configured to determine at least one content match code for the set of electronic content items. The at least one match code defines at least one characteristic of the set of electronic content items.

According to various exemplary embodiments, each content match code is associated with a style identifier and a style score for that style identifier. The style identifier identifies a style (ex: look and feel) that the electronic page to be created will have and the style score is a metric that indicates the degree to which the set of electronic content items is suitable for that style. Each style score may be a numerical score.

In various exemplary embodiments, a plurality of match codes are calculated for the set of electronic content items, with each match code being for a different style identifier and its associated style score. Accordingly, the suitability of the set of electronic content items for various styles of electronic pages is determined.

The various style identifiers for which a style score may be calculated may be article, educational document, publication, blog, diary, portfolio, art, emotion, story, event, invite, best-of, meme, fun, advertisement, sales, marketing, greetings, wish cards, personal messages and poster, but other styles may also be considered. There may be an unlimited number of possible style identifiers for an unlimited number of possible purposes of the electronic pages. Since style identifiers may be defined by users, users can continuously create new style identifiers.

The at least one content match code may be determined based on one or more properties of the set of electronic content items. For example, the one or more properties of the set of electronic content items can include one or more of number of items in the set, titles of one or more content items, descriptions associated to one or more content items, metatags embedded in one or more items, time stamps for one or more content items (ex: date created, date taken, date last modified), authors of one or more items, whether one or more content items are marked for private use or public use and sizes of one or more of the electronic content items.

According to various exemplary embodiments in which a plurality of match codes are determined and each match is associated with a style identifier and a style score, different rules may be applied to the above listed factors in determining the style scores associated to different style identifiers. For example, a first set of rules may be applied for calculating the style score for a first style identifier and a different second set of rules may be applied for calculating the style score for a second style identifier. For example, for an “article” style identifier, a set of rules that gives more weight to the length of text content items may be applied because articles tend to be more text-based. For example, for an “event” style identifier, a set of rules that gives more weight to the presence of dates, times and locations may be applied because an event is typically assigned a date, time and location.

According to various exemplary embodiments, additional factors other than properties of the set of electronic content items are considered for determining the at least one match code for the set of electronic content items. For example, user defined meta-tags may also be considered. These meta-tags may be defined during initialization of a page generation project or during selection of electronic content items that are to be included in the generated electronic page.

Additional factors may also include at least one property of a user participating in the page generation. The user may be participating by initializing the page generation environment, selecting one or more of the electronic content items, and giving the command to generate the electronic page. The at least one property of the user may be one or more of, but not limited to, user profile information, username of the user, the user's real name, the user's birthdate, the user's email address, preferences defined by the user, the user's social networking activities, the user's social networking connections, the user's gender, the user's age, the user internet browsing history, the user's interests, user electronic page-generation history, the user's likes, the user's shares and the user's travel preferences.

Additional factors may also include at least one contextual property. Contextual property refers to factors that are present at the time of the carrying out the generation of the electronic page. For example, the contextual property can include one or more of geolocation of the user device 16, identification of a contributor, identification of viewers, the type of user device 16 used, the platform/OS used, the time of the page generation, ongoing current events at the time of the page generation, current weather condition, the current season, and coincidence with a holiday.

It will be understood that according to various exemplary embodiments, the one or more content match codes are determined for the set of electronic content items as a whole. That is, content match codes are not calculated for electronic content items on an individual basis. Accordingly, the match codes are reflective of the set of electronic content items as a whole.

In some exemplary embodiments, intermediate match codes may be determined on a per item basis or on a subset of the items. These intermediate match codes are determined temporarily in order to determine the content match codes for the set of electronic content items as a whole. For example, intermediate match codes may be first calculated for individual items or subsets of items. This may be calculated based on properties of an item or subset of items. The intermediate match codes may be further adjusted based on user properties and/or contextual properties. For example, the content match codes may be different weighted averages of the intermediate match codes. The weighted approach may be tweaked because some criteria may have a stronger weight than others (ex: for different style identifiers).

Continuing with FIG. 2, the page-generation system includes a first database 56 of stored electronic page parts. Stored electronic page parts are elements from which an electronic page may be formed. An electronic page part may either define a structure of the page to be created, one or more static visual aspects of the electronic page to be created, one or more dynamic visual aspects of the electronic page, or one or more utilities of the electronic page.

An electronic page part that defines a structure of the page defines at least placeholders for containing electronic content items. For example, an electronic page part can define a layout or grid of placeholders. The electronic page part can also define a layout of placeholders for containing non-content items, such as banners, empty space, etc. In some example embodiments, multiple electronic page parts can operate together to define sub-layouts that may be placed within a parent layout. The sub-layout defines the placeholders for containing electronic content items. For example, “master” layout electronic page parts define the layout of an electronic page while “slave” layout electronic page parts define the layout of less than the whole electronic page part. “Slave” layout electronic page parts may be nested within a “master” layout or other “slave” layouts but a “master” layout cannot be nested within another layout page part.

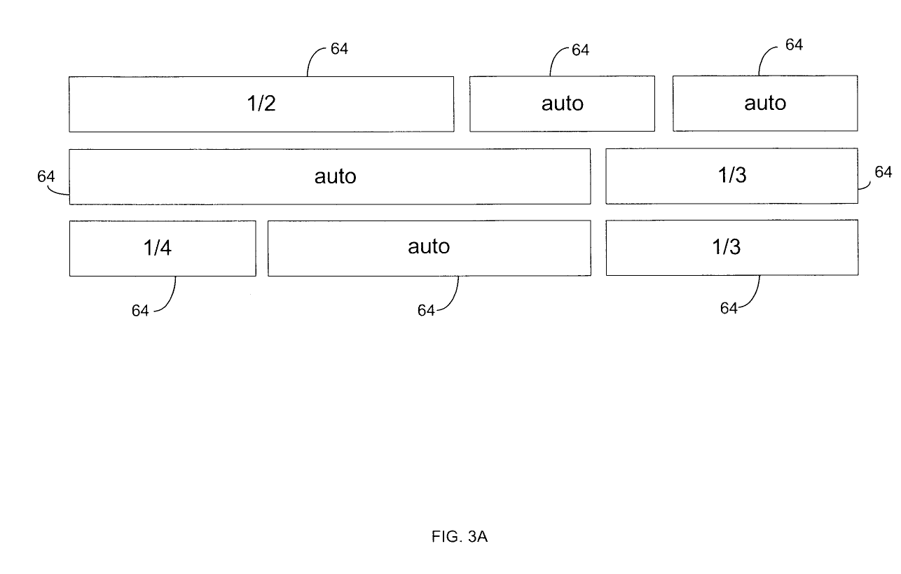

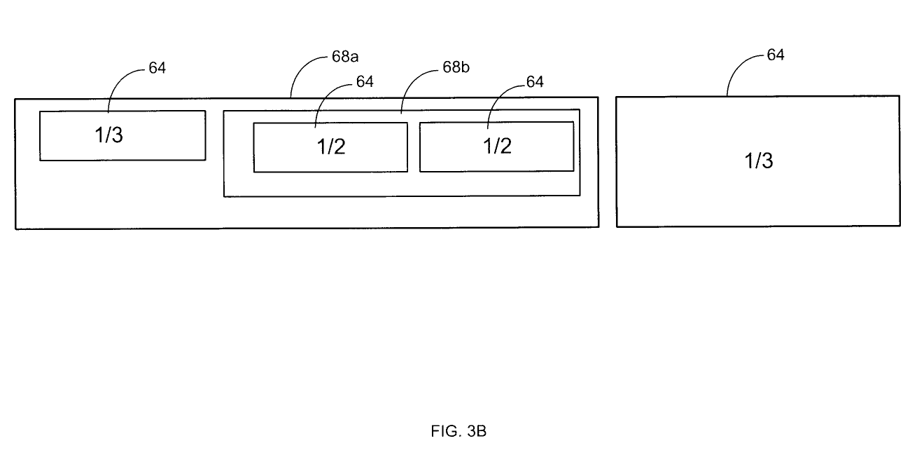

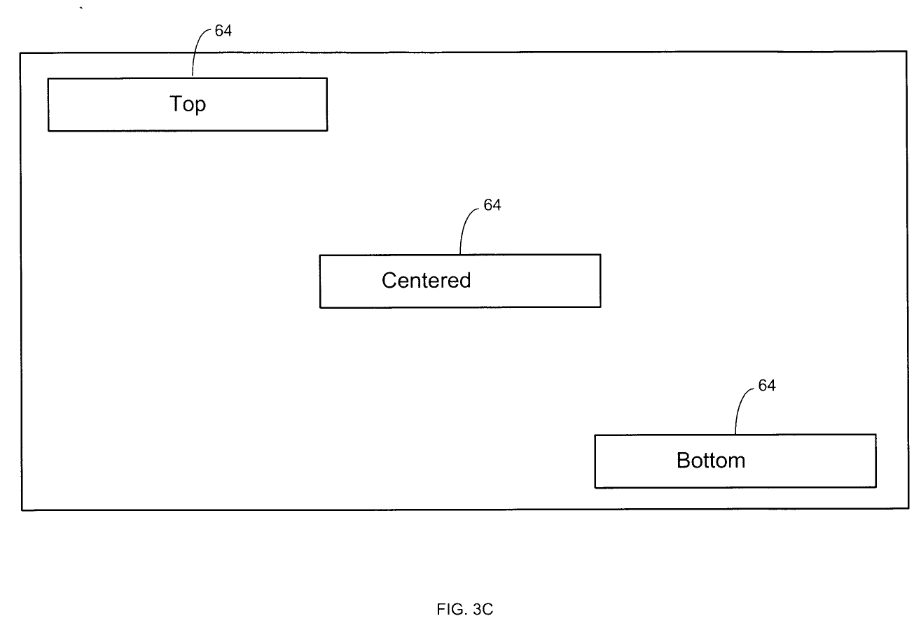

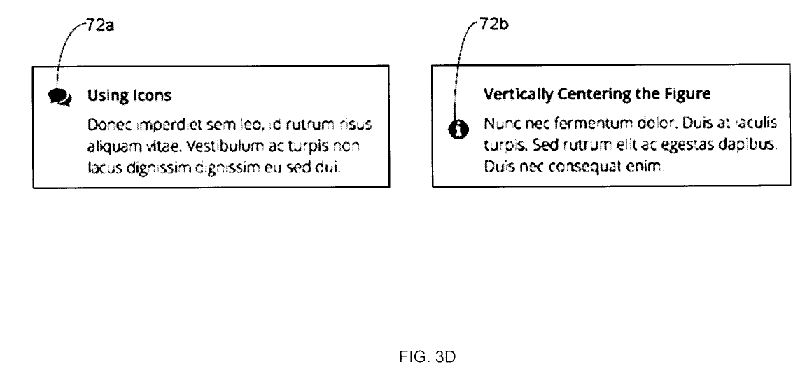

Referring now to FIG. 3A, therein illustrated is a schematic diagram of a first example layout of placeholders 64 defined by an electronic page part. Each placeholder may be assigned a height and width within the electronic page part. For example, the widths of the placeholders in the example are defined with respect to a full width of the page (which may be defined in the same electronic page part or within another electronic page part).

Referring now to FIG. 3B, therein illustrated is a schematic diagram of a second example layout of placeholders 64 defined by an electronic page part. It will be appreciated that the layout includes a first sub-layout 68a that defines one place holder and a further second sub-layout 68b. This second sub-layout 68b itself defines two additional placeholders 64 for electronic content items.

Referring now to FIG. 3C, therein illustrated is a schematic diagram of a third example layout of placeholders 64, in which placeholders 64 locations are defined with respect to the top (ex: top justified, bottom justified, vertically centered) and side edges (left justified, right justified, horizontally centered) of a layout or page.

Referring now to FIG. 3D, therein illustrated is a schematic diagram of two placeholders 64 in which the content items are contained in the placeholders 64 in different way. The different ways of containing the content items may be defined by one or more further electronic page parts. For example, in one of the placeholders, an electronic page part is applied that defines that a first icon 72a should be top justified while in the other of the placeholders, another electronic page part is applied that defines that a second icon 72b should be vertically center justified.

Static visual aspects of the page to be generated defined by one or more electronic page parts may include one or more of background properties, font type, font size, color schemes, etc. The electronic page parts may define these properties for the page as a whole, for individual layouts, sub-layouts or placeholders, or for individual content items contained in the placeholders.

Dynamic visual aspects of the page to be generated defined by one or more electronic page parts may include one or more of transitions, animations, sound, video playback settings and other visual effects. The electronic page parts may define these properties for the page as a whole, for individual layouts, sub-layouts or placeholders, or for individual content items contained in the placeholders.

Utilities of the electronic page to be generated defined by one or more electronic page parts may include utilities that cause the page to be “intelligent”. For example, the utilities may be operating viewable or hidden from view. The utilities may be operating in the background while the generated page is being viewed. For example, the utilities may be for collecting statistics related to the page, viewer data collection, data collection for advertising purposes, for sponsorship purposes, linking to partners, optimizing the page for search bots, optimizing based on contextual information metadata, metadata processing, analytics, etc.

It will be appreciated that typically a plurality of electronic page parts are combined to provide a particular look and feel to an electronic page that is to be generated. In some cases, two electronic page parts may be combined to define a single element of the page part (ex: part defining layout of placeholders, with part defining placement of content items within one placeholder, with part defining font and color within the placeholder).

According to various exemplary embodiments, some of the electronic page parts are stored as cascaded stylesheet (CSS) properties. Electronic page parts may also be stored as other markup, scripting or programming codesets. For example, the electronic page parts may be stored as one or more of LESS, SASS, CSS variant, JavaScript, HTML, classes, methods, objects, API calls, URLs, and pure text. For example, the markup or scripting language may be within W3C standards.

An example electronic page part stored as CSS and defining background color, header text color, header text alignment, body font type and size may be as follows:

<style>
body {

background-color: #d0e4fe;

}
h1 {

color: orange;
text-align: center;

}
p {

font-family: “Times New Roman”;
font-size: 20px;

}
</style>

An example electronic page part stored as CSS and defining transitions, animation and effects may be as follows:

<style>
div {

width: 100px;
height: 100px;
background-color: red;
animation-name: example;
animation-duration: 4s;

}
@keyframes example {

from {background-color: red;}
to {background-color: yellow;}

}
</style>

The electronic page parts stored in the database 56 may be provided by a user or administrator. For example, users may form a community of electronic page part contributors, wherein user-created parts may be uploaded and stored within the database 56 for use by other users in generating an electronic page. Additionally, or alternatively, programmers or designers employed by an entity administrating the page-generation system and service may create various electronic page parts that are stored within the database 56 for use by users that have access to the page-generation system 8.

Each stored electronic page part in the database 56 is associated with at least one part match code. The at least one match code defines at least one characteristic of the electronic page part.

According to various exemplary embodiments, each stored part match code is associated with a style identifier and a style score. The style identifier identifies a style of electronic page (ex: look and feel) that the electronic page part may be used for generating and the style score is a metric that indicates the degree to which the electronic page part is suitable for use in generating a page of that style. Each style score may be a numerical score.

The at least one match code associated to each stored electronic page part may be attributed to the electronic page part at the time the electronic page part is created and uploaded to the database 56. The at least one match code may be defined by the user or administrator that created the electronic page part. For example, the match code may be defined based on the style of page that the user or administrator intends the part to be used for. In other exemplary embodiments, the at least one match code may be edited by a community of users.

According to various exemplary embodiments, the at least one match code may also be updated and modified automatically based on its use in the generation of electronic pages. It will be understood that use of the generation of electronic pages may include one or more of how the electronic page part is used to generate different electronic pages, its use over time, the frequency of its use for generating pages, the popularity (ex: number of likes) of pages generated using the electronic page parts, which combinations of electronic page parts are most popular for page generation or for viewing, and which combinations are most liked. The updating of the match codes of a given electronic page part may be also be based on properties (ex: match codes) of other electronic page parts that are combined with the given electronic page part when generating an electronic page.

According to some exemplary embodiments, some of the stored electronic page parts may be defined as for public use. These parts may be used by any user. Furthermore, match codes associated to these page parts may be automatically updated base on their use by public users.

Other stored electronic page parts may be defined as for private use. These may be used only by their owners and collaborators. In such a case the match codes associated to these page parts can be set to only be updated manually. Alternatively, the match codes associated to these page parts may be updated automatically based on use by a defined community of private users.

A database 56 can include an assortment of electronic page parts to cover different styles of pages that may be generated from electronic content items. Furthermore, the electronic page parts may vary in complexity. For example, simple page parts are typically more basic and generic. These simple parts may be suitable for generating a variety of electronic page parts. Accordingly, the simple parts may each be associated to a large number of styles (style identifiers). However, the style scores associated to these style identifiers may be lower.

For example, more complex electronic page parts are more specifically suited to particular types or purposes of electronic page parts. Accordingly, the more complex parts may be associated to a single or low number of styles (style identifiers), but have higher style scores for these styles.

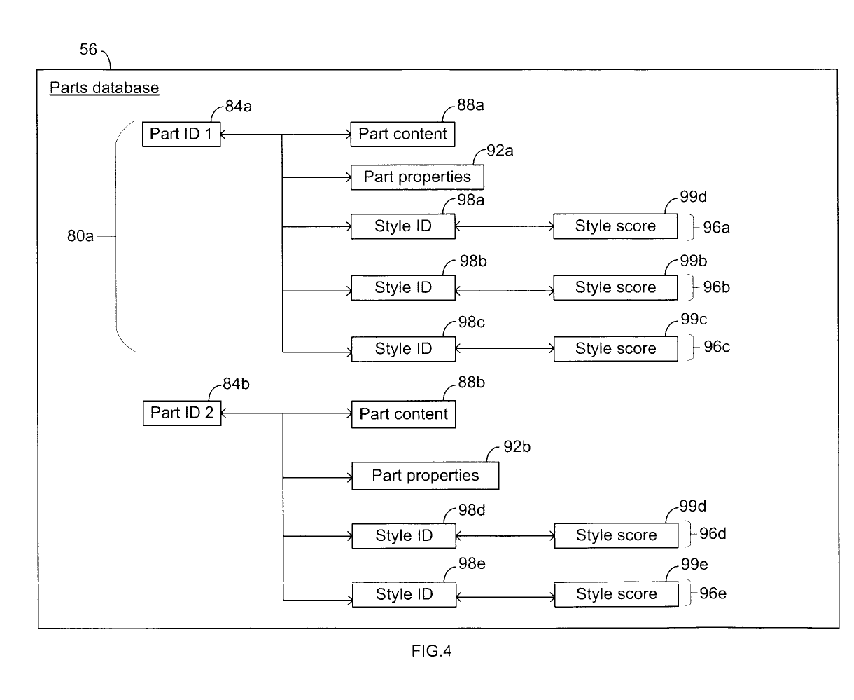

Referring now to FIG. 4, therein illustrated is a block diagram of a data structure of two electronic page parts 80a and 80b according to one exemplary embodiment of the database 56 of stored electronic page parts.

A first electronic page part 80a stored in the database 56 has a first part identifier 84a, which is associated with part content data 88a and part properties 92a. The part content data 88a includes the data that defines the structural aspects, static visual aspects or dynamic visual aspects of the electronic page that will be generated. For example, the part content data 88a includes the markup language, such as CSS code.

The part properties 92a contains various properties related to the first electronic page part 80a, such as author, date of creation, popularity, and type of electronic page part.

The first stored electronic page part 80a is associated to three match codes. A first match code 96a associated to the part 80a includes a first style identifier 98a, which is further associated to a first style score 98b. A second match code 96b associated to the part 80a includes a second style identifier 98b, which is further associated to a second style score 99b. A third match code 96c associated to the part 80a includes a third style identifier 98c, which is further associated to a third style score 99c.

Similarly, the second electronic page part 80b stored in the database 56 has a part identifier 84b, which is associated with part content data 88b and part properties 92b. The second stored electronic page part 80b is associated with two match codes. Match code 96d associated to the second part 80b includes a style identifier 98d, which is further associated to a second style score 99d. Another match code 96e associated to the second part 80b includes another style identifier 98e, which is further associated to style score 99e.

Referring back to FIG. 2, the page-generation system 8 includes a part-matching module 108. The part-matching module 108 determines electronic page parts stored in the parts database 56 that sufficiently match or is relevant to the set of electronic content items to be used for generating an electronic page.

According to various exemplary embodiments, the determining of which the stored electronic page parts are relevant to the set of electronic content items is carried out based on correspondences between the one or more match codes calculated for the set of electronic content items with the match codes associated to the stored electronic page parts. For example, the electronic pages parts that are determined to be relevant are those stored electronic page parts that are associated with match codes that closely match up with at least one match code calculated for the set of electronic content items.

According to various exemplary embodiments wherein each content match code is associated with its style identifier and style score and each part match code is associated with its style identifier and style score, determining which stored electronic page parts are relevant is based on the correspondence between the one or more style identifiers and style scores of the content match codes with the one or more style identifiers and style scores of the part match codes.

For example, content match codes having sufficiently high style scores may be identified. These may be a given number of content match codes associated to the highest style scores. Alternatively, these may be the match codes associated to those style scores that exceed a given first threshold. The style identifiers associated to these highest style scores are also identified. The parts database 56 is then searched to identify those electronic page parts having part match codes that are associated to these same style identifiers and that are also associated sufficiently high style scores. These style scores associated to part match codes may be those that exceed a given second threshold.

According to various exemplary embodiments, the part matching module 108 may further determine from the set of electronic content items particular number and/or types of electronic page parts that are required in order to generate an electronic page that will adequately present all of the electronic content items. For example, some types of electronic content items (ex: a social media network feed) may require one or more specific electronic page parts (ex: a placeholder that is adequate for displaying the social media network feed). Accordingly, the part matching module 108 may apply modified rules in order to find at least one relevant electronic page part that meets the required type. For example, a particular number of electronic content items may require one or more specific electronic page parts (ex: a layout part with sufficient placeholders). For example, a “calendar” type electronic item will require a page part that can accommodate this type of item. What types and/or numbers of items can be accommodate maybe defined with part properties associated to each stored electronic page part.

The suitability of an electronic page part based on numbers or types may further influence the determination of relevancy of the page part for the set of electronic content items. For example, if the set of electronic content items includes a given number of visual content items, a page part that can adequately display the visual content items will have higher relevancy.

The relevancy of one or more electronic page parts may be further determined based on user preferences. While user preferences may influence one or more style scores that are determined for a set of content items, user preferences may influence relevancy separately from the content match score. For example, when generating a given page, the user may set one or more preferences for that particular page (ex: dark background, light font) and page parts that fit these one or more preferences will be determined as being relevant (ex: page parts that define dark backgrounds and light fonts).

According to various exemplary embodiments, some part match codes are defined as public use. For example, these match codes may be for particular styles (style identifiers) of electronic pages that are commonly used. When a user is interacting with a user device 16 to generate an electronic page, these public part match codes may be automatically considered in order to determine the relevant one or more electronic parts that have match codes that sufficiently correspond to the content match codes determined for the set of electronic content items.

According to other exemplary embodiments, one or more part match codes may be defined as for private use. For example, these part match codes are only considered for determining relevant electronic page parts when generating an electronic page in a non-public situation (ex: within an organization).

In some examples, a user can define particular style identifiers of private match codes that must be considered in order to determine those electronic page parts associated to these particular style identifiers. For example, within an organization, it may be important for all generated electronic pages to have a consistent look and feel. Accordingly, private electronic page parts are created and associated with private match codes (ex: style identifiers for the organization). Accordingly, when generating an electronic page, a user within the organization can provide instructions to only consider electronic page parts associated to these private match codes. As a result, the generated electronic page will have this consistent look and feel.

According to various exemplary embodiments, style identifiers associated to part match codes may be ranked or organized in hierarchies. The ranking or hierarchical organization can be used to indicate specificity of style identifiers. For example, style identifiers of higher ranking can indicate a higher specificity. Accordingly, a correspondence between the content match code with a part match code associated to a higher ranked style identifier can indicate a higher relevance when compared to a correspondence with a part match code associated to a lower ranked style identifier.

For example, the style identifiers may be arranged in a parent-child relationship, wherein a child style identifier indicates more specificity than a parent style identifier. Accordingly, a correspondence between a content match code with a part match code associated to a child style identifier can indicate a higher relevance than a correspondence with a part match code associated to a parent style identifier.

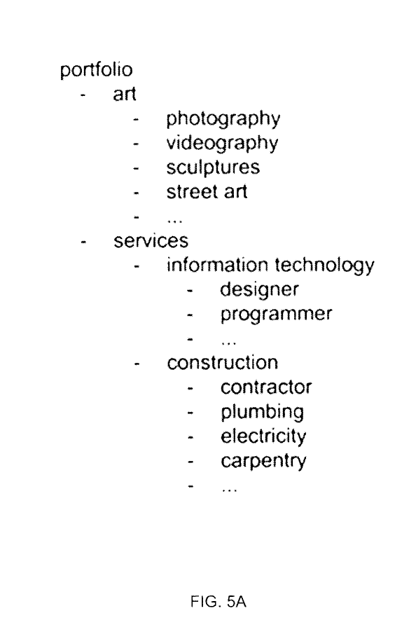

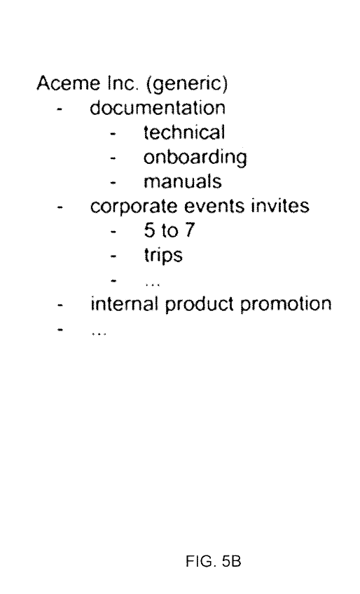

FIG. 5A illustrates an example of hierarchical organization of part match codes for public use. “Portfolio” style identifier is the highest level match code, which denotes lesser specificity. “Art”, “services” are children to “portfolio” and denote increased specificity. “Construction” style identifier is a child to “services” and is even more specific. “Contractor”, “plumbing”, “electricity” and “carpentry” are children to “construction” and denote a further level of specificity.

FIG. 5B illustrates an example hierarchical organization of part match codes for private use.

According to various exemplary embodiments, when determining relevant electronic page parts, if a first electronic page part has a style score that is not sufficiently high to indicate that the first electronic page part is relevant to the set of electronic content items, a second electronic page part associated to a style identifier that is a parent to the style identifier of the first electronic page part may be evaluated. The second electronic page part may not be as specific as the first electronic page part but may represent a better match (higher relevance) to the set of electronic page parts.

Referring back to FIG. 2, the page-generation system 8 further includes a page generation module 116. The page generation module 116 generates an electronic page from the set of electronic content items and the one or more relevant electronic page parts identified by the parts matching module 108. The page generation module 116 may determine in what order the electronic page parts are to be assembled in order to form the electronic page. The page generation module 116 may further determine how the relevant electronic page parts are applied to display the set of electronic content items. The page generation module 116 may also enforce rules, constraints and affinities derived from the relevant electronic page parts. The page generation module 116 therefore generates a set of instructions for arranging the set of electronic items with one or more of the relevant electronic page parts in order to create the electronic page.

The rules, constraints and affinities define relationships between electronic page parts when they are to be combined to generate a page part. For example, rules can define whether two given electronic page parts can be combined together or whether two given electronic page parts must be kept separate. A rule may be enforced in that it must absolutely applied. Alternatively, a rule may be a recommendation, in that the rule should be followed unless there is an overriding other rule.

Affinities may define optional rules for combining electronic page parts. For example one affinity may define that when a first part is chosen for generating a page, one or more other parts are highly compatible with the first part and should preferably be chosen for generating the page.

Constraints define dependencies between electronic parts. For example, a constraint can define a necessary link between two parts (two parts must be used together) or a necessary mutual exclusion between two parts (two parts must be kept separate).

According to various exemplary embodiments, the page generation module 116 may generate a plurality of electronic pages. From these pages, one of the pages is chosen as a preferred page while the other pages are considered as variants. The variant pages may be presented to the user where the user does not select the preferred page.

According to various exemplary embodiments, the page generation module 116 may save the set of instructions that arrange the set of electronic items as a stored arrangement within an arrangement database 124. The stored arrangement can then be re-used where similar electronic page parts are used. The stored arrangement may be used by the same user or with other users within a defined group. For example, within an organization (ex: company), re-using an arrangement can ensure that electronic pages are generated following the same set of rules.

A generated electronic page may be stored within pages database 132. In some exemplary embodiment, the electronic page is only stored after it has been approved by a user. The stored electronic page is then made available for viewing. The page may be made available to the public at large or to a defined group or defined groups of users.

While various modules and databases are shown to be housed within the page-generation system, it will be understood that according to various exemplary embodiments, some or all of the functionalities may be implemented on one or more of the user devices 16.

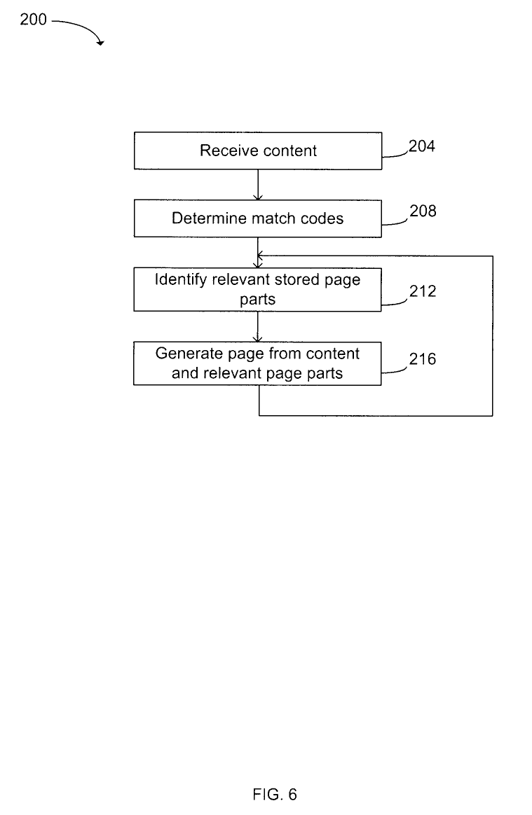

Referring now to FIG. 6, shown therein is a flow chart diagram illustrating an example embodiment of a method 200 for the generation of an electronic page. The method 200 may be performed by the processor of one or more user devices 16 being used by a user or by the processing device 32 of the page-generation system 8. In some exemplary embodiments, steps of the method 200 may be split between the processors of the user devices 16 and the processing device 32 of the page-generation system 8.

At step 204, the set of electronic content items selected for inclusion is received. For example, the some or all of the set of electronic content items may be selected by a user interacting with one or more of the user devices 16. For example, some or all of the electronic content items may be automatically selected by the page-generation system 8.

At step 208, at least one content match code is determined for the set of electronic content items.

At step 212, one or more electronic page parts that are relevant to the set of electronic content items are identified based on a correspondence between the at least one content match code with part match codes associated to stored electronic page parts.

At step 216, an electronic page is generated from the set of electronic content items and the one or more relevant electronic page parts. The generated electronic page may be further made available for viewing.

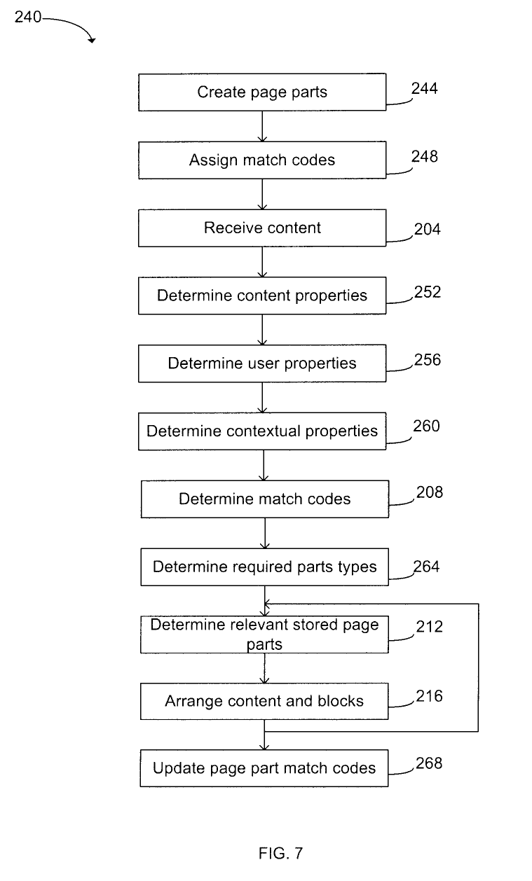

Referring now to FIG. 7, therein illustrated is a flowchart diagram illustrating a detailed method 240 for the generation of an electronic page. The method 240 may be performed by the processor of one or more user devices 16 being used by a user or by the processing device 32 of the page-generation system 8. In some exemplary embodiments, steps of the method 240 may be split between the processors of the user devices 16 and the processing device 32 of the page-generation system 8.

At step 244, electronic page parts are created and stored in the parts database 56. It will be understood that additional electronic page parts may be created on an ongoing basis. Electronic page parts may also be edited on an ongoing basis.

At step 248, one or more part match codes are attributed to the created electronic page parts. Associations between part match codes and created electronic page parts are also stored in the parts database 56.

At step 204, the set of electronic content items selected for inclusion is received.

At step 252, one or more properties of the set of electronic content items are determined.

At step 256, at least one property of a user participating in the page generation may optionally be determined.

At step 260, at least one contextual property surrounding the page generation process may optionally be determined.

At step 208, at least one content match code is determined for the set of electronic content items.

At step 264, types of electronic page parts that are required for the set of electronic content items may optionally be determined.

At step 212, one or more electronic page parts that are relevant to the set of electronic content items are identified based on a correspondence between the at least one content match code with part match codes associated to stored electronic page parts.

At step 216, an electronic page is generated from the set of electronic content items and the one or more relevant electronic page parts.

At step 268, one or more match codes associated to the electronic page parts may optionally be updated.

According to various exemplary embodiments, the determining of relevant stored page parts at step 212 and the generation of an electronic page at step 216 may be repeated. The repetition may be iterative or recursive. Repeating of steps 212 and 216 using different rules results in the creation of variant electronic pages.

It will be appreciated that various steps of method 200 or method 240 may be carried out in an other than the order illustrated in FIGS. 6 and 7. For example, the order of determining content properties, determining of user properties at step 252 and determining contextual properties at step 256 may be interchangeable. Similarly, the updating part match codes may be carried out on an ongoing base and at any time within method 240.

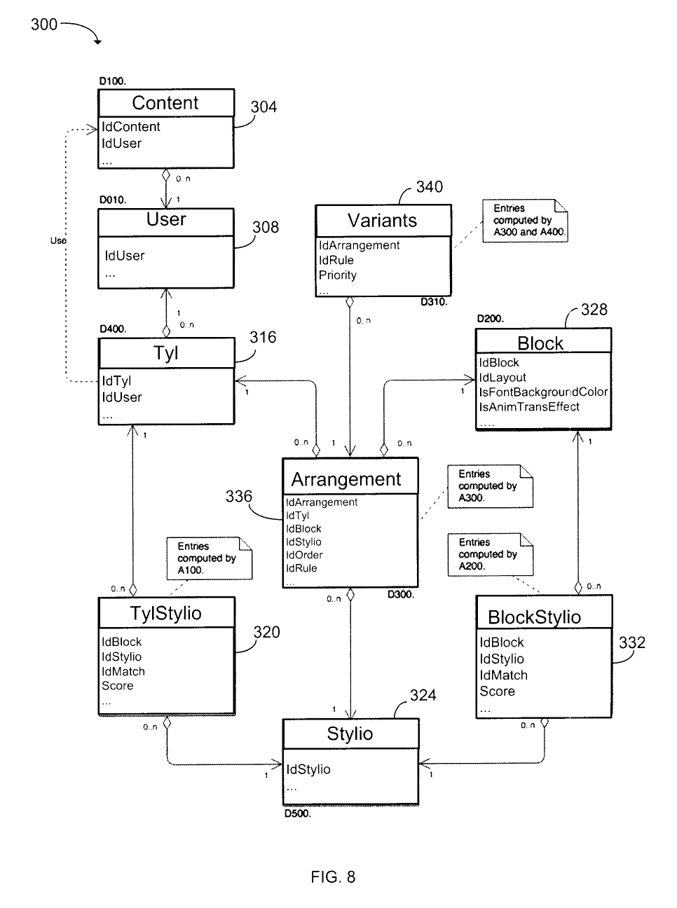

Referring now to FIG. 8, therein illustrated is a block diagram illustrating a structure 300 of data modules that are tracked within the electronic page-generation system 8. It will be understood that the data modules illustrate principal information stored in each data module, but that other information may also be stored in one or more of the data modules.

Content data module 304 stores electronic content items. These may include pre-stored electronic content items and user-uploaded electronic content items.

User data module 308 stores user data, such as user names, user preferences and user activities.

Page data module 316 (“Tyl”) stores electronic pages that have been generated. Each page is associated with the user(s) that generated the page.

Content match code data module 320 (“TylStylio”) stores content match codes that have been determined for sets of electronic items.

Style identifier data module 324 (“Stylio”) stores style identifiers. It may also store ranking or hierarchy of style identifiers.

Parts data module 328 (“block”) stores created electronic page parts.

Parts match code data module 332 (“BlockStylio”) stores match codes associated to the electronic page parts.

Arrangement data module 336 stores sets of rules that have been applied for generating electronic page parts.

Variant data module 340 stores sets of rules that have been applied for generating variant electronic page parts.

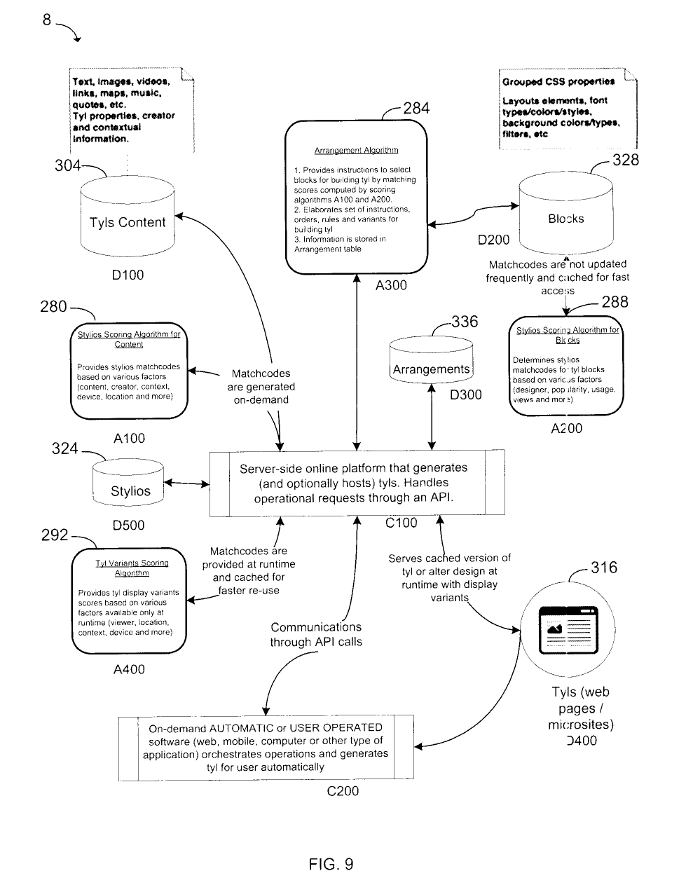

Referring now to FIG. 9, therein illustrated is a block diagram of detailed data modules and software modules of an exemplary page-generation system 8. The page-generation system 8 includes a scoring algorithm module 280, which may provide similar functionalities to the content scoring module 48 as described herein.

The system 8 further includes an arrangement algorithm module 284, which may provide similar functionalities to the part matching module 108 and page generation module 116 as described herein.

The system 8 further includes a part updating module 288, which provides the functionality of updating match codes associated to already created electronic page parts, as described elsewhere herein.

The system includes variant scoring module 292. The variant scoring module 292 implements functionalities that affect viewing of a generated electronic page. As an electronic page is being generated or after it has been generated, viewing variants of the page are also generated. These variants are slightly modified versions of the generated electronic page but are optimized for different viewing platforms, viewing conditions or viewer preferences. When a viewer selects a generated electronic page to be viewed, the viewing platform, current viewing condition and/or viewer preferences may be determined and a variant that best suits these may be presented to the viewer.

According to various exemplary embodiments, variant electronic pages are generated in real time from the relevant electronic page parts and set of electronic content items and variant rules for generating the page. The variant rules may be determined based on the viewing platform, viewing conditions or viewer preferences. When a viewer selects a generated electronic page to be viewed, the viewing platform, current viewing condition and/or viewer preferences may be determined and an electronic page is generated in real time that is best suited for presentation to the viewer.

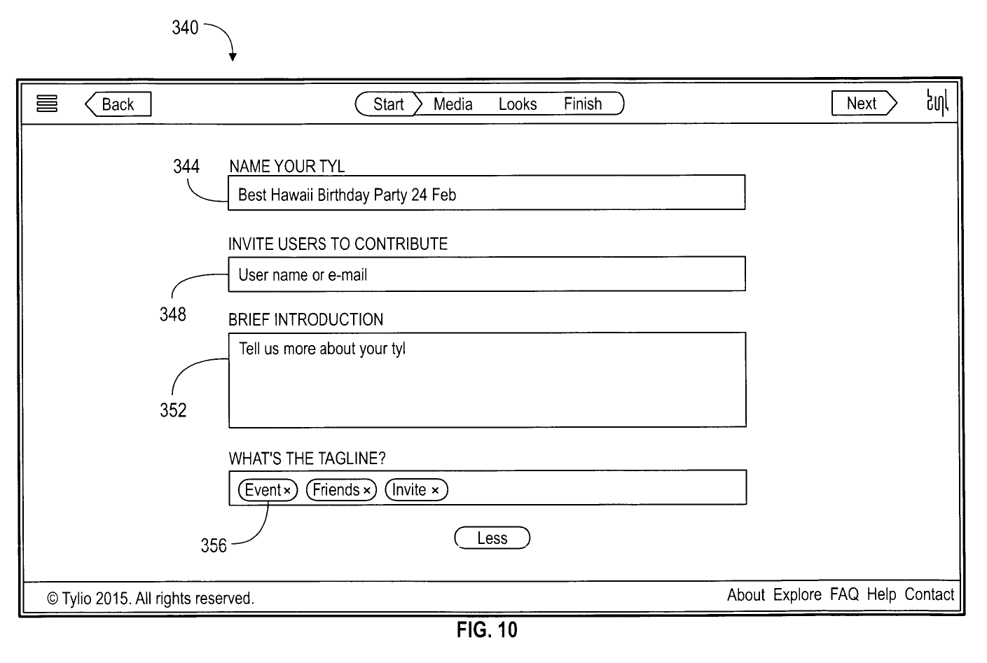

Referring now to FIG. 10, therein illustrated is an example user environment 340 for initiating an electronic page-generation process. The environment may be presented within a standalone app or a browser operating on a user device. The initialization environment includes a first space 344 for entering a title of the page to be generated. The environment 340 also includes a space 348 for entering coordinates of other users that are to be invited to participate in the page-generation process. The initialization environment may include a third space 352 for entering a description. The initialization environment includes a fourth space 356 for assigning tags. The tags may be metatags for the page to be generated. The tags may also influence the determining of the one or more match codes for the set of electronic content items to be included in the page to be generated.

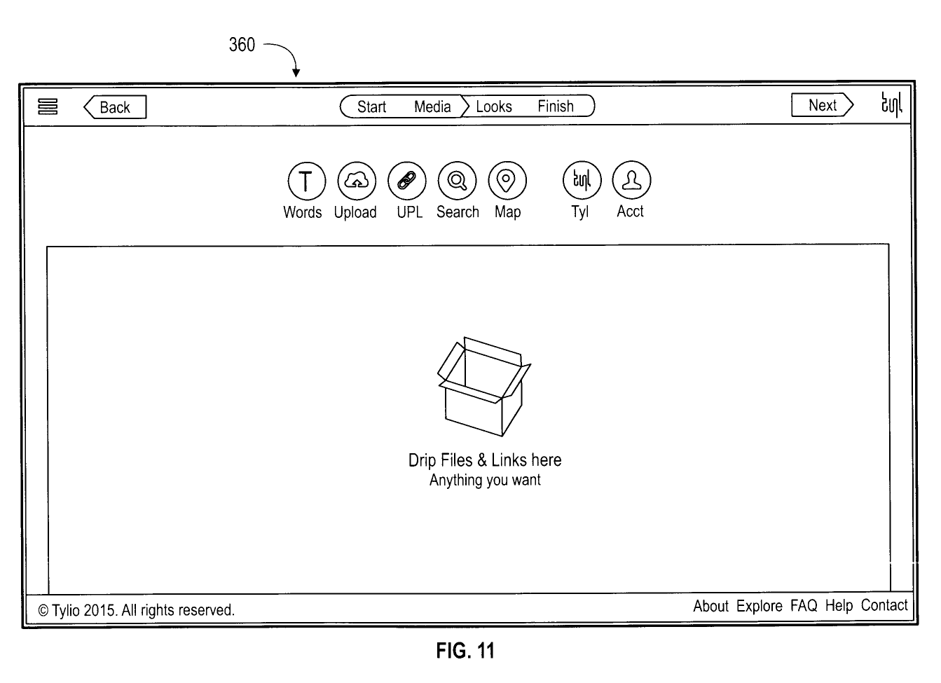

FIG. 11 illustrates an empty example user environment 360 for selecting electronic content items to be included in the page to be generated.

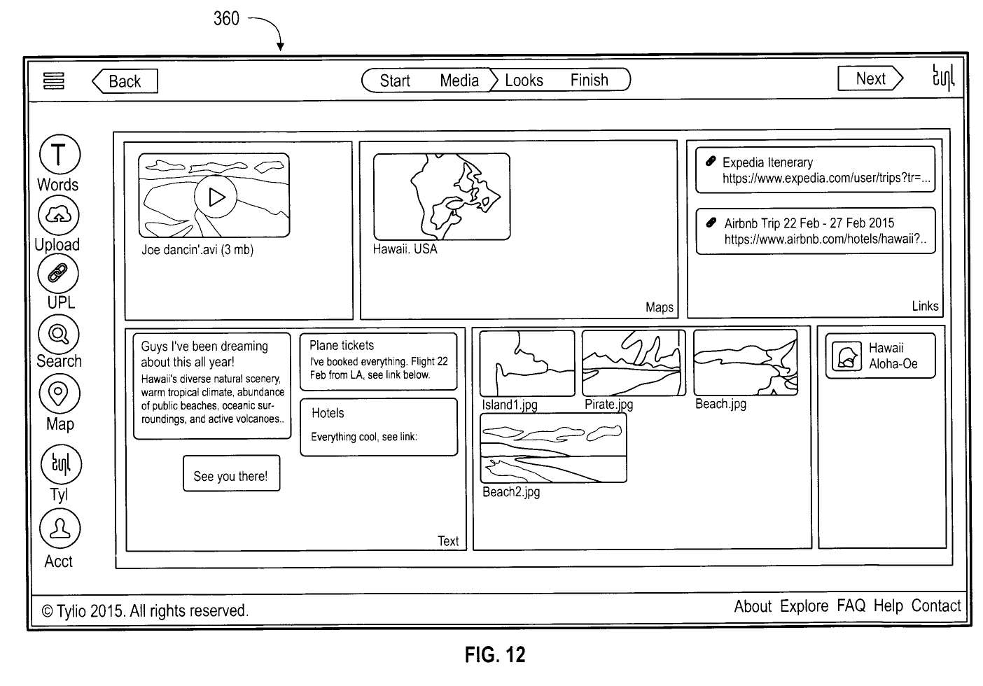

FIG. 12 illustrates an exemplary user environment 360 in which various types of electronic content items have been selected. Selected content items are shown in the environment 360. These items may be organized by their types and placed in different zones. In the illustrated example, selected content items include a video, map, links, text entries, images and audio file.

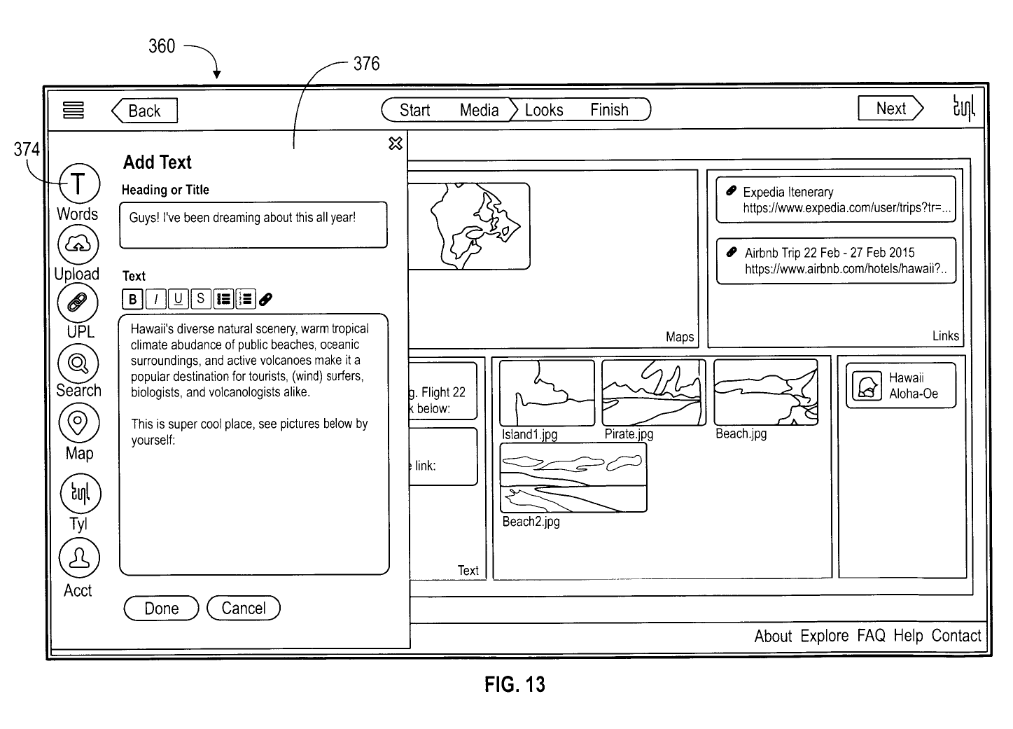

FIG. 13 illustrates the example user environment 360 in which a text entry is to be created. By selecting a new text entry icon 374, a text entry interface 376 is displayed and additional text 378 can be entered.

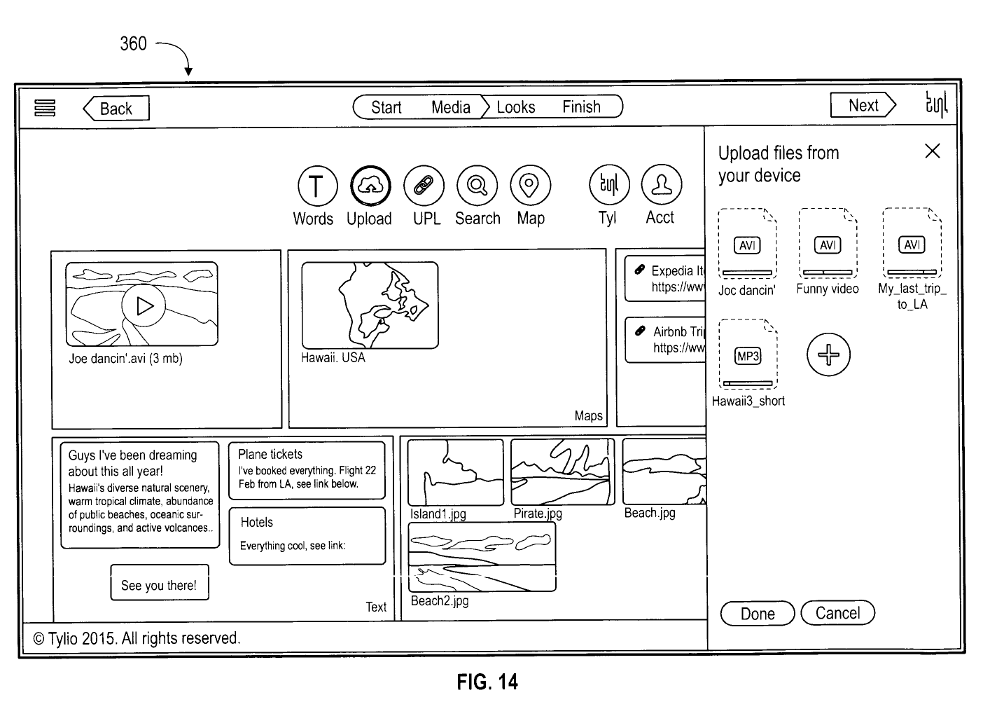

FIG. 14 illustrates the example user environment 360 in which multimedia content items are selected and uploaded.

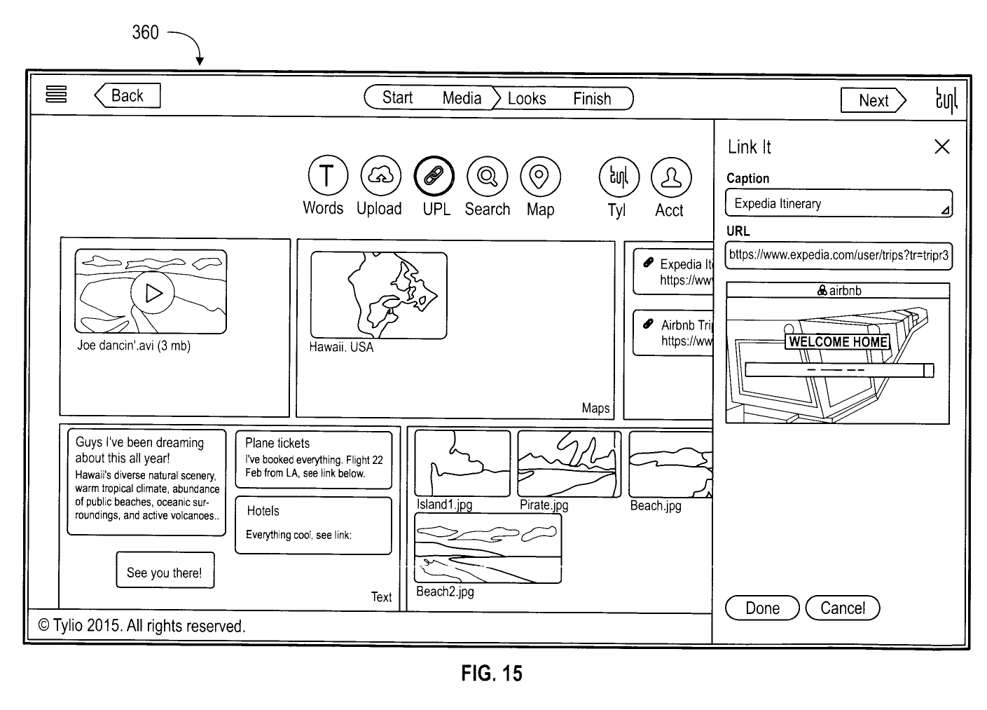

FIG. 15 illustrates the example user environment 360 in which link content items are selected.

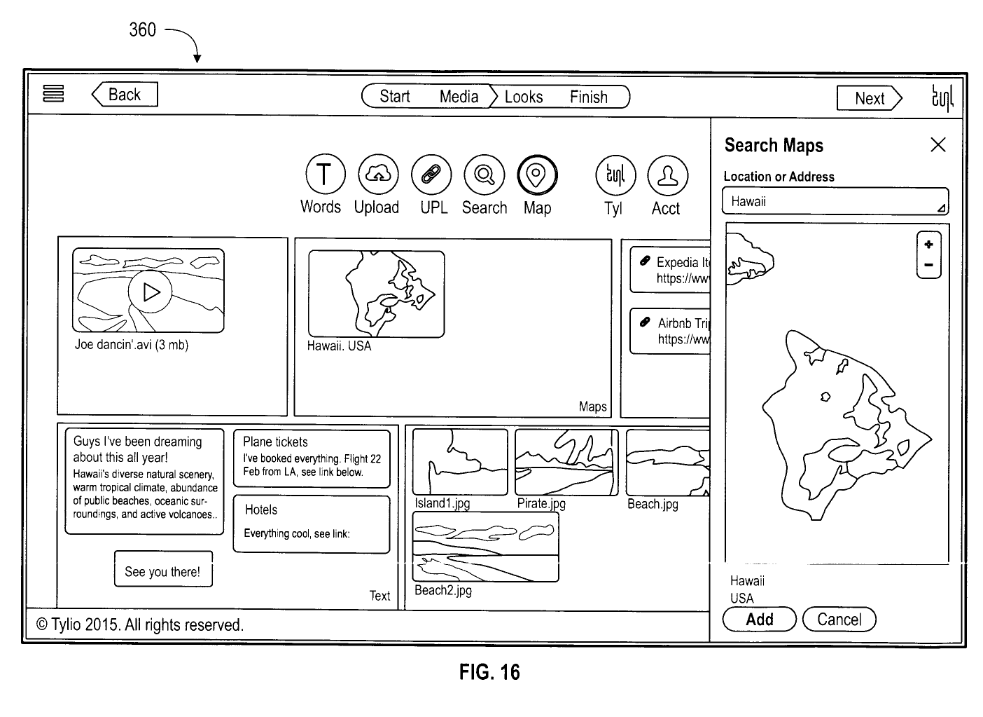

FIG. 16 illustrates the example user environment 360 in which map content items are selected and uploaded.

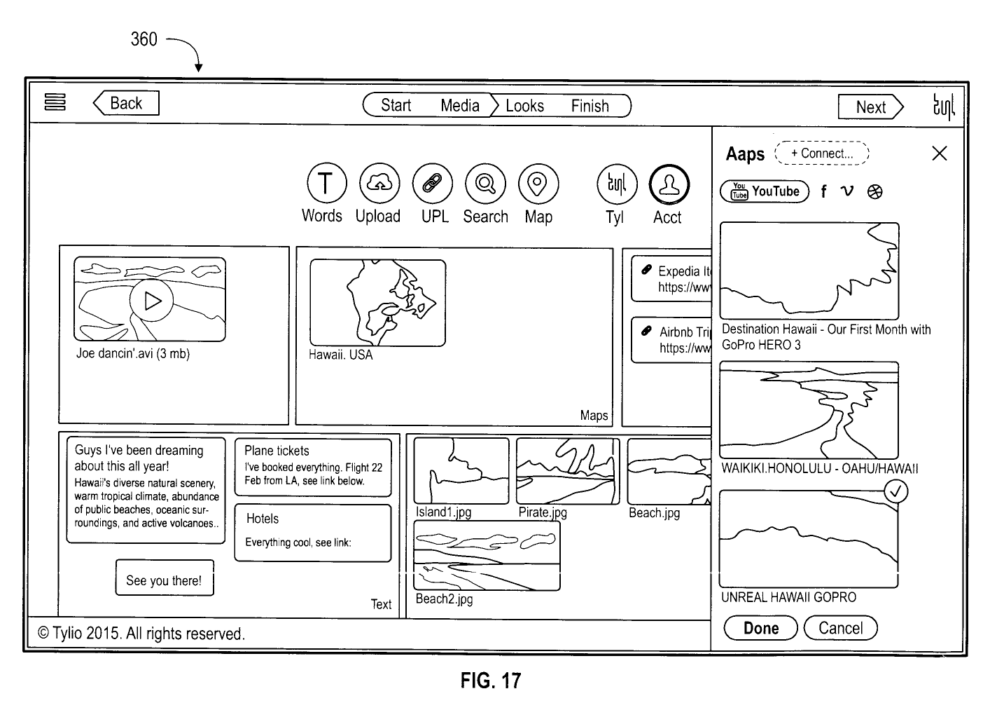

FIG. 17 illustrates the example user environment 360 in which social networking content items are selected and uploaded.

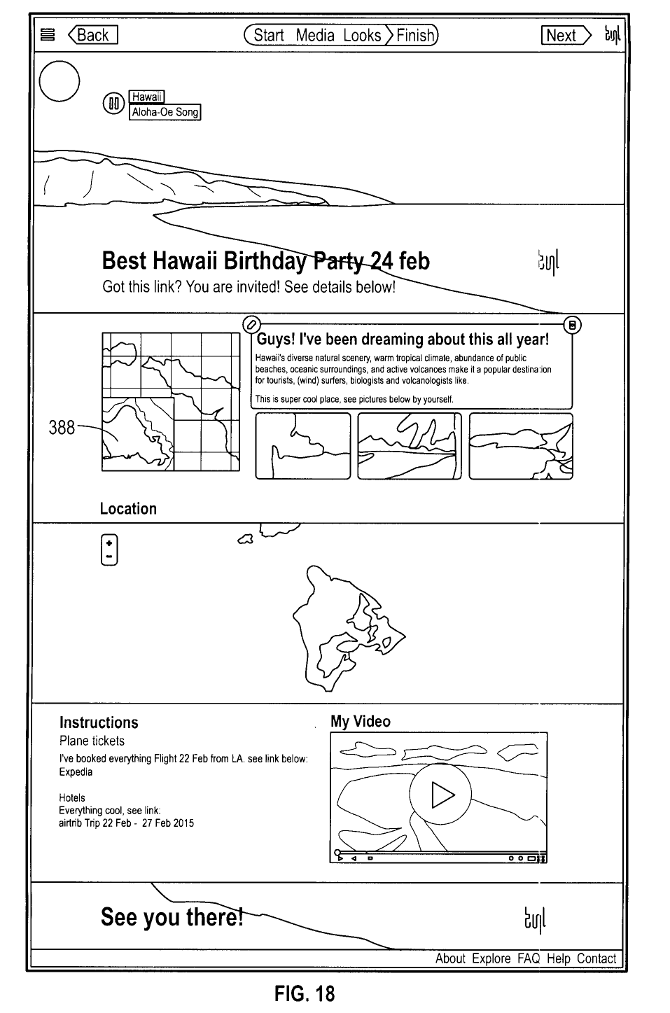

FIG. 18 illustrates an example electronic page that is a webpage that is generated from the selected content items of FIGS. 12 and 17 from implementing methods and systems for generating an electronic page, as described herein. It will be appreciated that the selected electronic content items shown in FIGS. 12 to 17 have been placed within the generated electronic page. Furthermore, based on the content of this selected content item, the page generation module further automatically retrieved an external content item that is an atlas map 388.

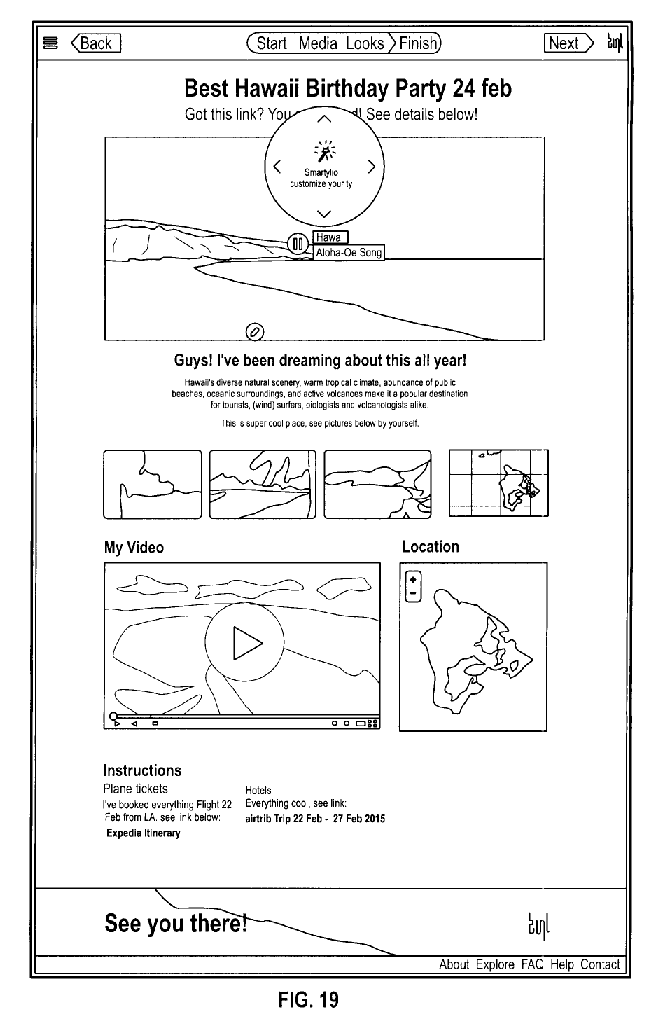

FIG. 19 illustrates an example variant electronic page that is a webpage that is generated from the selected content items of FIGS. 12 to 17 from implementing method and systems for generating an electronic page, as described herein. It will be appreciated that the selected electronic content items shown in FIGS. 12 to 17 have also been placed but in a different arrangement from the arrangement of FIG. 18.

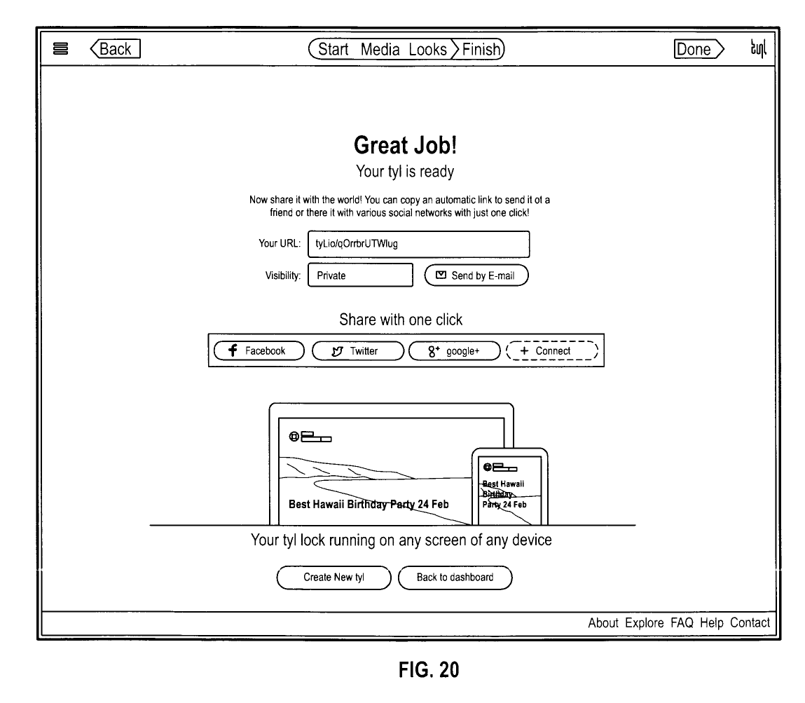

FIG. 20 illustrates a user environment 380 confirming completion of the generation of an electronic page. A link to the generated page is shown. An option for making public or keep private the page is also provided. Options for sharing the page on various social media networks is also provided. Thumbnails show examples of the page on different devices. According to various exemplary embodiments, a user may be presented with an option to download a copy of the generated electronic page for offline storage.

It will be appreciated that various exemplary embodiments for generating an electronic page described herein greatly simplifies a user's task in creating such a page. In particular, a user does not need to handle any programming code and/or markup language. Furthermore, due to the comparing of content match codes with part match codes to determine relevant electronic page parts, the look and feel of a generated electronic page will be suited to its purpose. The use of multiple electronic page parts further provides variety in the electronic page. A user does not need to select a template and/or further modify that template in order to produce an electronic page that is attractive while also being distinctive. Accordingly, the user's experience in creating an electronic page may be improved.

The embodiments of paragraphs [0011] to [00163] of the present disclosure are presented in such a manner in the present disclosure so as to demonstrate that every combinations of embodiments, when applicable can be made. These embodiments have thus been presented in the description in a manner equivalent to making dependent claims for all the embodiments that depend upon any of the preceding claims (covering the previously presented embodiments), thereby demonstrating that they can be combined together in all possible manners. For example, all the possible combination, when applicable, between the embodiments of paragraphs [0011] to [00163] and the processes of paragraphs [0008] to [0010] are hereby covered by the present disclosure.

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

1. A method for generating an electronic page, the method comprising:
receiving a set of electronic content items for inclusion into the electronic page;
determining one or more content match codes for the set of electronic content items;
determining from a database of stored electronic page parts one or more relevant electronic page parts, each stored electronic page part being associated with one or more part match codes, a given stored electronic page part being identified as one of the relevant electronic parts based on a correspondence between its one or more part match codes and the one or more content match codes determined for the set of electronic content items; and
generating an electronic page from the set of electronic content items and the one or more relevant electronic page parts.

2. The method of claim 1, wherein each content match code is associated with a style identifier and a style score;
wherein each part match code is associated with a style identifier and a style score; and
wherein a given stored electronic page part is identified as one of the relevant electronic parts based on at least one style identifier and its associated style score for its one or more part match codes and a style identifier and its associated style score for at least one of the content match codes.

3. The method of claim 1 or 2, wherein the given stored electronic page part is identified as one of the relevant electronic parts if at least one of the content match codes has a style score that exceeds a first predetermined threshold, if one of the part match codes of the given stored electronic part has a style score that exceeds a second predetermined threshold and if the style score that exceeds the first predetermined threshold and the style score that exceeds the second predetermined threshold are associated to the same style identifier.

4. The method of any one of claims 1 to 3, wherein a subset of the one or more relevant electronic page parts are chosen based on at least one rule, constraint or affinity, and wherein the electronic page is generated from the subset of the one or more relevant electronic page parts.

5. The method of any one of claims 1 to 4, wherein the electronic page is a web page; and
wherein the set of electronic content items comprises at least one visual web content item.

6. The method of any one of claims 1 to 5, wherein the one or more relevant electronic page parts comprises at least one layout part defining a layout of content placeholders; and
wherein generating the electronic page comprises placing the set of electronic content items within the content placeholders.

7. The method of any one of claims 1 to 6, wherein the electronic content items are chosen from multimedia content, images, graphics, text, comments, links, audio, video, maps, social media feed, and interactive web content.

8. The method of any one of claims 1 to 7, wherein the one or more content match codes are determined based on one or more properties of the electronic content items.

9. The method of claim 8, wherein the properties of the electronic content items are chosen from the number of items in the set, title, description, metatag, file timestamp, author, private use, public use, and size.

10. The method of any one of claims 1 to 9, wherein the electronic page parts are chosen from page layout, background, font, color, transition, animation, page visual effect, master layout, slave layout, page utilities, data collection utility, advertising utility, sponsorship utility, linking utility, search bot utility, metadata utility, and analytics utility.

11. The method of any one of claims 1 to 10, further comprising:
defining the stored electronic page parts; and
attributing the one or more part match codes to the defined electronic page parts.

12. The method of claim 11, wherein the one or more part match codes are user-defined.

13. The method of claim 11 or 12, further comprising:
updating the one or more match codes of at least one of the relevant electronic page part based on its use in generating the electronic page.

14. The method of claim 13, wherein the one or more match codes of at least one of the relevant electronic page part are updated based on the one or more match codes of the stored electronic page parts.

15. The method of any one of claims 1 to 14, wherein the set of electronic content items are received from a selection made by a user;
wherein the method further comprises determining at least one property of the user; and
wherein the one or more content match codes are determined based on the at least one user property.

16. The method of claim 15, wherein the at least one user property is chosen from user profile information, username, user's real name, birthday, email, user-defined preferences, social networking activities, social network connections, gender, age, user interest, user history, user travel preferences.

17. The method of any one of claims 1 to 16, further comprising determining at least one contextual property; and
wherein the one or more content match codes are determined based on the at least one contextual property.

18. The method of claim 17, wherein the at least one contextual property is chosen from geolocation, contributor identification, viewer identification, type of creating device, platform of creating device, time, ongoing current events at the time of the page generation, current weather condition, the current season, and coincidence with a holiday.

19. The method of any one of claims 1 to 18, wherein each stored electronic page part is further associated to a part type;
wherein the method further comprises determining based on the set of electronic content items at least one required electronic page part type; and
wherein the electronic page is generated from the one or more relevant electronic page parts of the required types.

20. The method of any one of claims 1 to 19, wherein the category of the content match code and the category of part match code is chosen from article, educational, publication, blog, diary, portfolio, art, emotion, story, event, invite, best-of, meme, fun, advertising, sale of goods, marketing, greetings, wish cards, personal messages and poster.

21. A system for generating an electronic page, the system comprising:
a memory for storing a plurality of instructions;
a processor coupled to the memory, the processor configured for:
receiving a set of electronic content items for inclusion into the electronic page;
determining one or more content match codes for the set of electronic content items;
determining from a database of stored electronic page parts one or more relevant electronic page parts, each stored electronic page part being associated with one or more part match codes, a given stored electronic page part being identified as one of the relevant electronic parts based on a correspondence between its one or more part match codes and the one or more content match codes determined for the set of electronic content items; and
generating an electronic page from the set of electronic content items and the one or more relevant electronic page parts.

22. The system of claim 21, wherein each content match code is associated with a style identifier and a style score;
wherein each part match code is associated with a style identifier and a style score; and
wherein a given stored electronic page part is identified as one of the relevant electronic parts based on at least one style identifier and its associated style score for this one or more part match codes and a style identifier and its associated style score for at least one of the content match codes.

23. The system of any one of claims 21 to 22, wherein the given stored electronic page part is identified as one of the relevant electronic parts if at least one of the content match codes has a style score that exceeds a first predetermined threshold, if one of the part match codes of the given stored electronic part has a style score that exceeds a second predetermined threshold and if the style score that exceeds the first predetermined threshold and the style score that exceeds the second predetermined threshold are associated to the same style identifier.

24. The system of any one of claims 21 to 23, wherein a subset of the one or more relevant electronic page parts are chosen based on at least one rule, constraint or affinity, and wherein the electronic page is generated from the subset of the one or more relevant electronic page parts.

25. The system of any one of claims 21 to 24, wherein the electronic page is a web page; and
wherein the set of electronic content items comprises at least one visual web content item.

26. The system of any one of claims 21 to 25, wherein the one or more relevant electronic page parts comprise at least one layout part defining a layout of content placeholders; and
wherein generating the electronic page comprises placing the set of electronic content items within the content placeholders.

27. The system of any one of claims 21 to 26, wherein the electronic content items are chosen from multimedia content, images, graphics, text, comments, links, audio, video, maps, social media feed, and interactive web content.

28. The system of any one of claims 21 to 27, wherein the one or more content match codes are determined based on one or more properties of the electronic content items.

29. The system of claim 28, wherein the properties of the electronic content items are chosen from title, description, metatag, file timestamp, author, private use, personal use, and size.

30. The system of any one of claims 21 to 29, wherein the electronic page parts are chosen from page layout, background, font, color, transition, animation, page visual effect, master layout, slave layout, page utilities, data collection utility, advertising utility, sponsorship utility, linking utility, search bot utility, metadata utility, and analytics utility.

31. The system of any one of claims 21 to 30, the processor being further configured for:
defining the stored electronic page parts; and
attributing the one or more part match codes to the defined electronic page parts.

32. The system of claim 31, wherein the one or more part match codes are user-defined.

33. The system of claim 31 or 32, the processor being further configured for updating the one or more match codes of at least one of the relevant electronic page part based on its use in generating the electronic page.

34. The system of claim 33, wherein the one or more match codes of at least one of the relevant electronic page part are updated based on the one or more match codes of the stored electronic page parts.

35. The system of any one of claims 21 to 34, wherein the set of electronic content items are received from a selection made by a user;
wherein the processor is further configured for determining at least one property of the user; and
wherein the one or more content match codes are determined based on the at least one user property.

36. The system of claim 35, wherein the at least one user property is chosen from user profile information, username, user's real name, birthday, email, user-defined preferences, social networking activities, social network connections, gender, age, user interest, user history, and user travel preferences.

37. The system of any one of claims 21 to 36, the processor being further configured for determining at least one contextual property; and
wherein the one or more content match codes are determined based on the at least one contextual property.

38. The system of claim 37, wherein the at least one contextual property is chosen from geolocation, contributor identification, viewer identification, type of creating device, platform of creating device, time, ongoing current events at the time of the page generation, current weather condition, the current season, and coincidence with a holiday.

39. The system of any one of claims 21 to 38, wherein each stored electronic page part is further associated to a part type;
wherein the processor is further configured for determining based on the set of electronic content items at least one required electronic page part type; and
wherein the electronic page is generated from the one or more relevant electronic page parts of the required types.

40. The system of any one of claims 21 to 39, wherein the category of the content match code and the category of part match code is chosen from article, educational, publication, blog, diary, portfolio, art, emotion, story, event, invite, best-of, meme, fun, advertising, sale of goods, marketing, greetings, wish cards, personal messages and poster.

41. A tangible computer readable medium including computer executable instructions which, when executed on a computing device, cause the computing device to carry out the method of any one of claims 1 to 20.
